(19) United States
(12) Patent Application Publication
(10) Pub. No.: US 2006/0125145 A1
(43) Pub. Date: Jun. 15, 2006

(54) Rotational plastics molding with internally mounted mold features

(75) Inventors: Nathan King, Rosemount, MN (US); Charles Wesley Carlsen, Edina, MN (US)

Correspondence Address: SCHWEGMAN, LUNDBERG, WOESSNER & KLUTH, 121 S. 8TH STREET, SUITE 1600, MINNEAPOLIS, MN, 55402, US

(73) Assignee: Solar Plastics, Inc.

(21) Appl. No.: 11/008,442

(22) Filed: Dec. 9, 2004

(51) Int. Cl. B29C 41/04

(52) U.S. Cl. 264/310; 425/435

(57) ABSTRACT

A rotational mold for plastic objects includes a feature body assembled in an aperture of a main body such that the object can be released from the main body before releasing it from the feature body. In some cases, the feature body may be repositioned on the main body to manufacture different versions of the object with the same mold.

### TECHNICAL FIELD

The present subject matter relates to plastics molding, and more specifically concerns accommodating a range of features in rotational molds and molded objects.

### BACKGROUND

Rotational molding involves heating a plastic resin in a hollow mold while rotating the mold slowly in two axes, so as to melt and distribute the resin over the inside of the mold by gravity alone. Rotational molding can fashion large, sturdy objects beyond the abilities of spin molding or blow molding, which employ centrifugal force or pressure to distribute resin over the mold walls. More complex shapes are possible. Articles produced by rotational molding also possess uniform wall thicknesses and other desirable properties.

For these reasons, rotational molding is often employed in manufacturing large containers, such as storage and fuel tanks. As one example, fuel tanks for industrial and agricultural vehicles commonly have complex shapes to maximize capacity in oddly shaped available spaces. As manufacturers seek to reduce costs by converting from metal to plastic tanks, rotational molding offers sufficient durability for this purpose.

A typical rotational mold has a cast or fabricated aluminum, stainless steel, or similar body having a number of pieces that fit together along one or more parting lines. A framework, typically of metal tubing, seals the body pieces together and mounts the mold to a rotational molding machine. After the resin has cured, the body pieces are parted along one or more lines of draw perpendicular to the planes of the parting lines.

Some molded objects may require features to be molded outside or against a line of draw when demolding the finished object. Furthermore, some molded objects may have multiple versions that differ only in the position or orientation of a feature, so that a single reconfigurable mold would be less expensive than multiple complete molds for the different versions.

Such features have been molded with additional separate mold pieces that are mounted to one or more exterior surfaces of the mold before the mold is heated, and that are removed from the outside prior to parting the main body of the mold to remove the major portion of the cured object. Features of this type may include bosses, fill necks, handles, level-measuring structures, hinges, fillports for loading the mold cavity with resin, and many other shapes and structures.

Some molded objects, however, have features that may make them difficult or even impossible to mold with this process. FIG. 1, for example shows a rotational mold 100 for a fuel tank having a parallelopiped main body 110 and a separate raised feature body 120 for attaching a fuel line (not shown) by means of a laterally extending coupling 121. One version of the object has coupling 121 extending in the direction of arrow 122, while another version may orient coupling 121 in the direction of arrow 123. Attaching feature body 120 to the exterior surface 111 of main body 110 along sealing line 112 would cause feature body 120 to interfere with surface 111 if it were parted, say along a feature-body parting line such as 112. Alternatives such as bolting a feature body to the main body along a flange entirely outside the main body are possible, but have disadvantages such as visible parting lines, additional cost, and/or higher mold maintenance. Arrows 113 indicate the draw line of main body 110.

A need thus exists for configuring a feature body on a main body of a rotational mold to allow a greater range of feature structures and to allow fabrication of different versions of a rotational mold.

### DRAWING DESCRIPTION

FIG. 1 is a perspective view of a conventional rotational mold.

FIG. 2 is a perspective view of a rotational mold according to an embodiment of the invention.

FIG. 3 is a broken-away section showing the attachment of the two mold bodies of FIG. 1

FIG. 4 is a plan of an alternative rotational mold.

FIG. 5 is a flowchart of an example molding process.

FIG. 6 shows a molded object produced by the mold of FIG. 4.

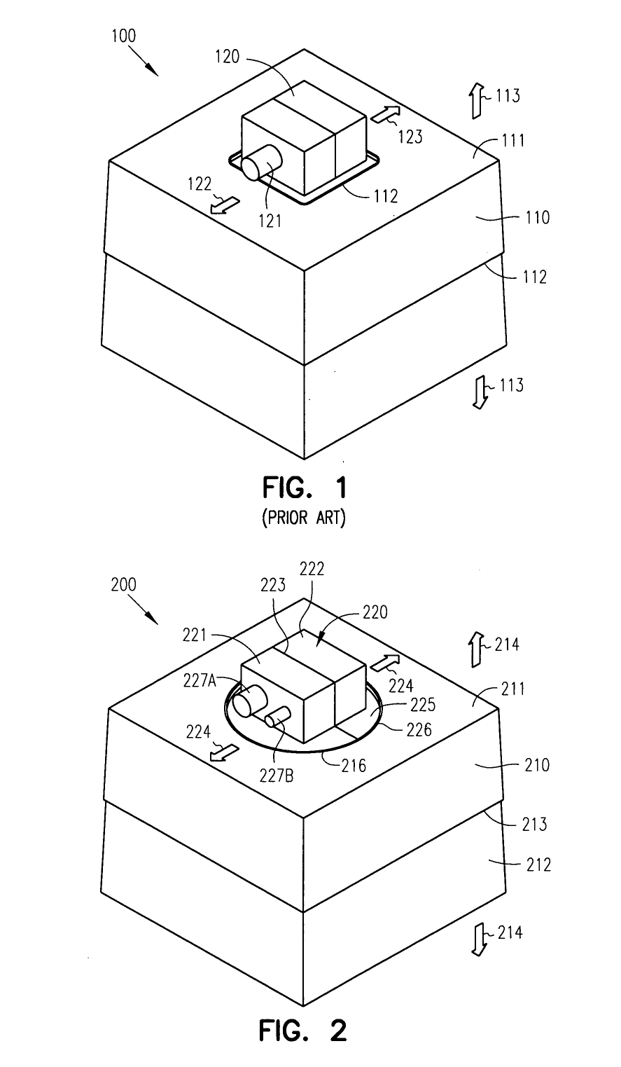

### DESCRIPTION OF EMBODIMENTS

FIG. 2 shows a rotational mold 200 having a main body 210 for forming a portion of an object. Main body 210 comprises two main-body pieces, 211 and 212, although more may be included if desired. Pieces 211 and 212 are sealed together by an external framework or other fastener (not shown) along main-body parting line 213. Although the parting line may include steps or similar deviations, it substantially defines a plane. When curing is complete, mold pieces 211 and 212 are separated or parted along a draw line 214 that is substantially perpendicular to this notional plane.

A feature body 220 defines a feature on the surface of the molded object. In this example, the feature is a “doghouse” for attaching an external fuel line to a fuel tank formed by main body 210. This feature may have many shapes and functions, such as bosses, fill necks, handles, level-measuring structures, hinges, and fillports for loading the mold cavity with resin. Features may be raised from the surface of main body 210, depressed into it, or both.

Feature body 220 comprises two feature-body pieces 221 and 222, separated by a feature-body parting line 223. Line 223 may deviate to a considerable extent, but it substantially defines a plane to which a feature-body draw line 224 is generally perpendicular. In addition to the portion that defines the desired feature shape, feature body 220 includes a flange 225 that extends along at least one surface 211 of main body 210. A periphery 226 of flange 225 sealingly engages an aperture 216 in main body 210. Although shown lying entirely within one of the main-body pieces 211, it may lie in any of the pieces, or may extend over more than one piece.

Feature parting line 223 extends across flange 225, so that the flange has separate portions associated respectively with feature-body pieces 221 and 222; stated alternatively, the pieces 221 and 222 have flange portions that meet along parting line 223.

Flange periphery 226—and thus also aperture 216—extend beyond any protrusion of feature body 210 that extends laterally in a direction perpendicular to main-body draw line 214, so that parting main body 210 therealong does not interfere with feature body 220. For example, aperture 216 extends beyond the horizontal projection of bosses 227A, 227B in the side of the feature body.

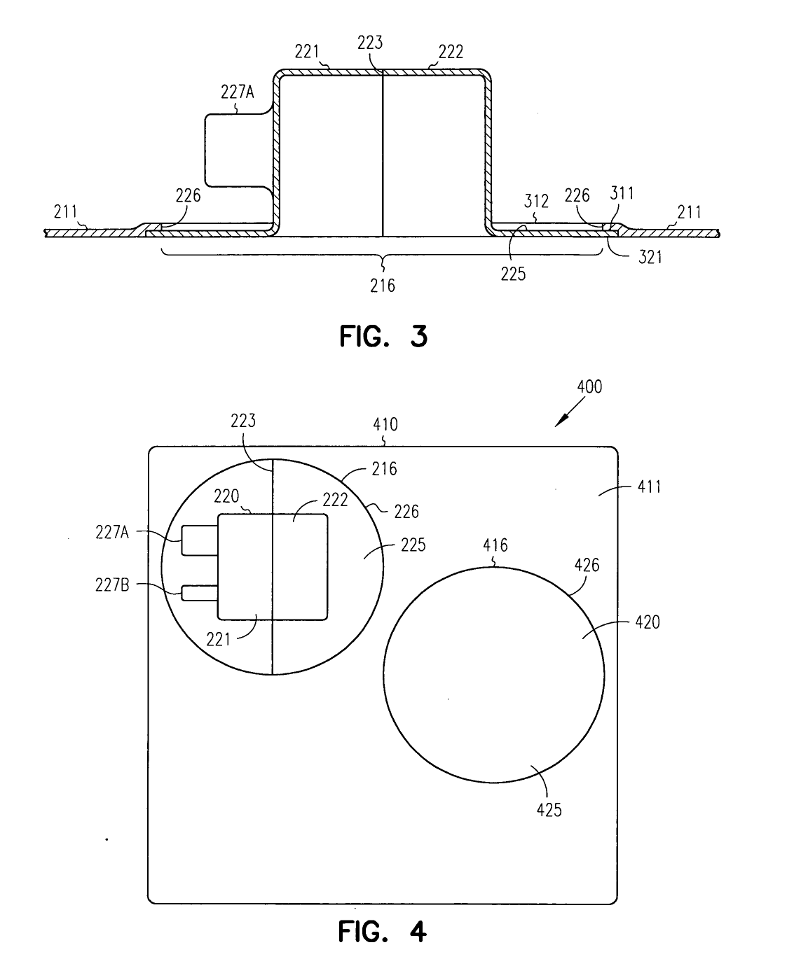

Feature body 220 is attached to main body 210 such that the main body can be parted before feature body 220 is parted and removed from the finished object. FIG. 3 is a sectional view showing one example of attaining this objective. In this example, flange 225 includes a lip portion 321 that is slightly larger than the periphery 226 of aperture 216 in main body piece 211. Periphery 226 includes a corresponding raised shelf 311 that seals against lip 321. Lip 321 and shelf 311 may partially or completely surround flange 225 or aperture 216. In most applications, the interior surfaces of lip 321 and main body mold piece 211 are made flush. Making the interior surface of the feature body flush or coplanar with the interior surface of the main body eliminates unwanted mold marks on the finished product. Feature body 220 may be held to main body 110 in a number of ways. In one example, a conventional frame (not shown) holds main-body pieces 211, 212 together during the rotational molding operation; in that case, a subframe (not shown) may hold it in position so that flange 225 remains sealed to piece 211 during the operation. Throughout this description, references to the shape of the aperture or of the flange (or its edge) refer to the portions thereof that engage or mate or with each other.

Besides extending beyond lateral protrusions of the feature body, aperture 216 may permit mounting feature body 220 on main body 210 in multiple different positions or orientations. In the example of a fuel tank, a customer may desire several different orientations of bosses 227A, B, so that a fuel hose may lead off in different directions for different equipment models, or for multiple tanks on different sides of a single engine. In the example of FIG. 2, aperture 216 has a circular shape, permitting flange edge 226 to engage it at any desired angle. (Throughout, references to a shape of aperture 216 implies the same shape for edge 226 of flange 225, at least of that portion which sealingly engages the aperture.) If only four different directions are desired, aperture 216 might be a square; other polygons may provide other discrete positions. More generally, symmetry about a point in the plane of the flange permits multiple positions of the feature body relative to the main body. In these cases also, aperture 216 extends beyond the lateral ends of features such as 227A, B for any orientation or position in which it may be desired to attach feature body 220.

The present concept also allows a feature to be placed at different locations of a mold body. FIG. 4 is a top plan of a mold 400 having a main body 410 with an upper piece 411. In this example, feature body 220 is located at aperture 216 near a corner of piece 411. Another aperture 416 may be positioned at another location on main-body piece 410, or on another main-body piece (not shown). A flat blank plate 420 of the same outer shape as feature body 220 may sealingly engage aperture 416 at flange 426. Then, if some customers desire a molded object having the feature near the center, for example, feature body 220 may be merely swapped with plate 420. Of course, plate 420 may also comprise a second feature body, so that multiple disconnected features may be molded into the object. If the two feature-body flanges and apertures are suitably configured, each may have different orientations, independently of each other. In this case, of course, the apertures 216 and 416, and the corresponding flanges 226 and 426, may have different sizes and/or shapes. If they are the same, however, the two different feature bodies can also be swapped with each other.

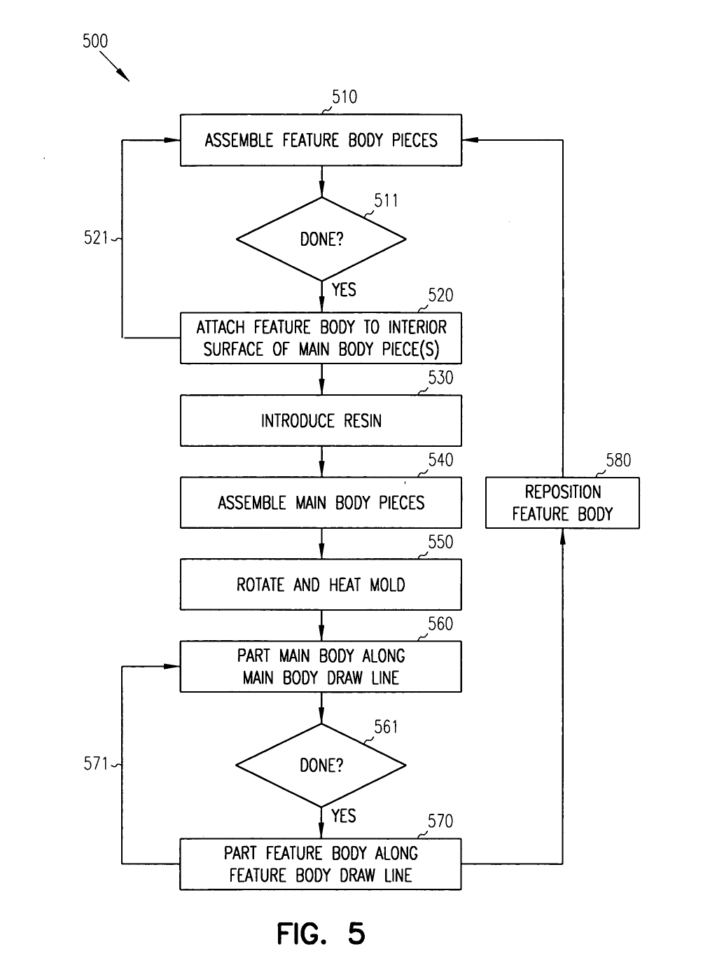

FIG. 5 describes an example rotational molding method 500. Operation 510 assembles the pieces, such as 221-222 of feature body 220, FIG. 2, together along parting line 223. Operation 520 attaches the assembled feature body to apiece such as 211 of main body 210. The attachment or mounting may be done as shown in connection with FIG. 3, or in other convenient ways. Operation 530 introduces the desired uncured resin into a main-body mold piece, and operation 540 assembles the mold pieces 211-212 along parting line 213 so as to seal them together. This may be accomplished with a frame or other attachment mechanism, as described above. In some cases, the resin may be introduced after assembly 540 through a fillport or other means, if desired. Block 550 heats and rotates the resin. This operation is conventional, and may employ known parameter values for the size, shape, material of the molded object, and possibly other factors as well.

After completion of operation 550, block 560 separates at least some of the main-body pieces along parting line 213, in the general direction of draw line 214. Parting may involve removing a frame or other operations. This releases a portion of the molded object from at least one of the main-body mold pieces such as 211-212, but leaves feature body 220 still attached to the molded object. After the object has been released from the main body at 561, operation 570 releases the object from the feature body by parting the pieces such as 221-222 along parting line 223. Pulling the pieces apart substantially in the direction of draw line 224 may accomplish this goal. Draw line 224 is usually not parallel with main-body draw line 214; in the examples illustrated herein, these draw lines are substantially perpendicular to each other. Because the planes of parting lines are perpendicular to their respective draw lines, corresponding relations hold with respect to the parting planes also. Detaching or disassembling part of a frame or subframe may be involved in this operation.

The examples in FIGS. 2-4 show feature-body flanges 225 and 425 that are coplanar with a surface of main body 210 or 410. However, these two surfaces need not be coplanar, or even parallel, as long as the feature-body flange can be sealed to the interior of the main body in a manner such that the main body is removable or releasable from the molded object without removing the feature body at the same time.

As mentioned previously, a main body may include more than one feature body. In this event, operations 510-520 and 560-570 may be repeated, either sequentially or simultaneously, as indicated by arrows 521 and 571, for any additional feature bodies. Furthermore, a feature body may include a subfeature body, and so on. In this event, operations 510-520 and 560-570 may be iterated, substituting “subfeature body” for “feature body” and “feature body” for main body.” That is, nested features and subfeatures may permit the molding of more complex object shapes.

Different versions of a molded object may be manufactured by repositioning one or more feature (or subfeature bodies) as shown at 580, and then repeating operations 510-570 with the feature body in its new position, to produce a different molded object. A new position may involve a reorientation of one or more feature or subfeature bodies or moving it (or them) to different locations on the main or feature bodies.

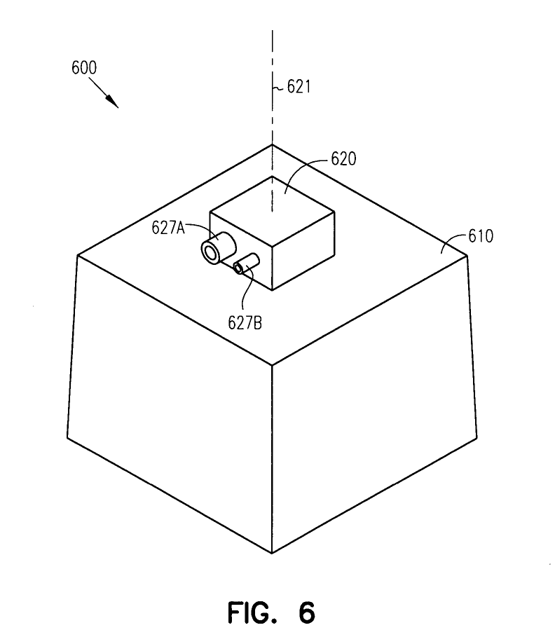

FIG. 6 is a perspective view of the molded object 600 produced from a mold such as 200, FIG. 2, according to a method such as 500, FIG. 5. In this example, object 600 may be a tank having a hollow body 610 for holding fuel or other fluid, surmounted by a “doghouse” 620 having a connection 627A for a feed line (not shown) and a connection 627B for a vent or return line. The ends of these connections may be opened by any conventional process, during or after the molding operation. A variation of this object having, say, connections rotated at any desired angle about axis 621 may be manufactured easily from the same mold 200 as described above.

### CONCLUSION

The foregoing description and drawing figures illustrate certain aspects and embodiments sufficiently to enable those skilled in the art to practice the invention. Other embodiments may incorporate structural, process, and other changes. Examples merely typify possible variations, and are not limiting. Individual components, structures, and functions are optional unless explicitly required, and operational sequences may vary. Portions and features of some embodiments may be included in, substituted for, or added to those of others. The word “or” herein implies one or more of the listed items, in any combination, and singular forms include plural. The required Abstract is provided only as a search tool, and not for interpretation of the claims. The scope of the invention encompasses the full ambit of the claims and all available equivalents, and each claim represents a separate embodiment unto itself.

1. A rotational mold, comprising:
a main body having an interior surface defining a first portion of a molded object and having an aperture therethrough;
a feature body having an interior surface defining a second portion of the molded object, and having a flange conforming to the aperture,
where the feature-body flange extends beyond any other part of the feature body in a manner such that the main body is removable from the molded object without removing the feature body from the molded object.

2. The mold of claim 1 where the feature body comprises a plurality of feature-body pieces that are separable for removing them from the molded object.

3. The mold of claim 2 where the feature-body pieces are separable in a plane substantially perpendicular to a plane formed by the flange.

4. The mold of claim 1 where the aperture is located in only one of the separable main-body pieces.

5. The mold of claim 1 where the feature-body flange extends beyond any other part of the feature body in a direction substantially perpendicular to the plane of the flange.

6. The mold of claim 1 where the shape of the flange is symmetrical about a point in the plane of the flange.

7. The mold of claim 6 where the flange is circular.

8. The mold of claim 6 where the flange is polygonal.

9. The mold of claim 1 where the interior surface is substantially flush with an interior surface of the feature body.

10. A rotational mold, comprising:
a main body having an interior surface defining a first portion of a molded object and having an aperture therethrough;
a feature body having an interior surface defining a second portion of the molded object, and having a flange conforming to the aperture;
a mount for sealing the feature body to the interior surface of the main body such that the main body is removable from the molded object without removing the feature body from the molded object.

11. The mold of claim 10 further comprising:
a further aperture through the main body;
a further feature body having a further flange conforming to the further aperture;
a further mount for sealing the further feature body to the interior surface of the main body such that the main body is removable from the molded object without removing the further feature body from the molded object.

12. The mold of claim 11 where both of the apertures have the same size and shape.

13. The mold of claim 10 where the mount includes a shelf formed in the interior surface of the main body, at least partially surrounding the aperture.

14. The mold of claim 13 where the flange includes a lip for engaging the shelf.

15. The mold of claim 14 where the lip sealingly engages the shelf.

16. The mold of claim 13 where the mount includes a raised area in the main body at least partially surrounding the aperture.

17. A method for rotational molding of a plastic object, comprising:
attaching a feature body to a main body of a mold to the interior through an aperture in the main body so as to seal the feature body to the main body;
introducing a plastic resin into the mold;
heating and rotating the mold so as to cure the resin;
separating the main body so as to remove it from the object without removing the feature body;
thereafter, separating the feature body to remove it from the object.

18. The method of claim 17 where separating the main body includes separating multiple main-body pieces in a first direction.

19. The method of claim 17 where separating the feature body includes separating multiple feature-body pieces in a second direction not parallel to the first direction.

20. The method of claim 17 where the object is a first object and the feature body is attached to the main body in a first position, further comprising, after separating the feature body:
reattaching the feature body to the main body through the aperture in a second position relative to the main body;
introducing a plastic resin into the mold;
heating and rotating the mod so as to cure the resin;
separating the main body so as to remove it from the object without removing the feature body;
thereafter, separating the feature body to remove it from the object.

21. The method of claim 20 where the second position has a predetermined angle relative to the first position.

22. The method of claim 17 further comprising attaching a further feature body to the interior of the main body of the mold through a further aperture in the main body so as to seal the further feature body to the main body.

23. The method of claim 22 further comprising swapping the feature bodies with each other.
